(19) United States
(12) Patent Application Publication
(10) Pub. No.: US 2003/0196340 A1
(43) Pub. Date: Oct. 23, 2003

(54) Cable compass

(76) Inventor: James J. Harris, Davidson, NC (US)

Correspondence Address: Adams, Schwartz & Evans, P.A., 2180 Two Wachovia Center, Charlotte, NC, 28282, US

(21) Appl. No.: 10/124,926

(22) Filed: Apr. 18, 2002

(51) Int. Cl. B43L 9/02

(52) U.S. Cl. 33/27.031

(57) ABSTRACT

A compass is provided for marking, scoring or cutting curves on a surface. The compass includes an instrument holder adapted for receiving and holding a surface-engaging instrument. An adjustable-length cable has a proximal end secured to the holder and a free end for being anchored to the surface a selected distance from the holder. The selected distance defines a radius of a curve formed by operation of the compass.

### TECHNICAL FIELD AND BACKGROUND OF INVENTION

This application relates to a cable compass for marking, scoring or cutting curves on a surface. The invention is especially useful for forming circles of large radii. The radii of the circles may range from several inches to a hundred feet or more. The invention has application in the formation of curves and circles on construction sites, wall murals, athletic fields, and the like.

A variety of compass assemblies for forming curves and circles about a given stationary point is known. These include conventional compass structures with V-shaped frames which are hinged at their apexes. Pointed stylus tips and/or sharp marking instruments are secured to the frames of these structures at different locations. In some assemblies, the marking instruments are inserted into short cylinders integrally formed with or otherwise attached to the v-shaped frames. The marking instruments are then retained within the cylinders by hinged elements.

While the above-described compasses provide means for forming relatively small curves and circles on a given surface, there are limitations associated with their use. For example, the diameter of the circle being drawn or marked is limited to the size and the length of the v-shaped frames and their ability to separate their tips. Also, because the pointed tips and the marking instruments which are attached to the sides of the frames are maintained in a predetermined spacing during usage, any undesired lateral movement within the frame structures results in the formation of asymmetrical circles. Finally, conventional v-shaped compasses are limited to using marking devices, typically lead or ink, that fit into predetermined holes on the tips of the frames.

### SUMMARY OF INVENTION

Therefore, it is an object of the invention to provide a cable compass used for forming circles of a wide range of radii, and which does not employ a conventional V-shaped frame.

It is another object of the invention to provide a cable compass which is especially applicable for forming curves and circles having relatively large radii.

It is another object of the invention to provide a cable compass which will accommodate a variety of styluses for marking as well as for scoring and cutting surfaces.

It is another object of the invention to provide a cable compass which restricts undesirable lateral and axial movement of the stylus during use.

It is another object of the invention to provide a cable compass which is easy to operate.

It is another object of the invention to provide a cable compass which is relatively inexpensive to manufacture.

It is another object of the invention to provide a cable compass which is conveniently adjusted to allow ready formation of multiple size curves and circles.

These and other objects of the present invention are achieved in the preferred embodiments disclosed below by providing a compass for marking, scoring or cutting curves on a surface. The compass includes an instrument holder adapted for receiving and holding a surface-engaging instrument. An adjustable-length cable has a proximal end secured to the holder and a free end for being anchored to the surface a selected distance from the holder. The selected distance defines a radius of a curve formed by operation of the compass.

The term “cable” is defined broadly herein to include any elongated member capable of extending from one point to another. The cable length is “adjustable” in that any selected length of cable within a prescribed range may be extended from the instrument holder. For example, the cable length may range from 0 to 100 feet.

According to another preferred embodiment of the invention, a mobile housing is attached to the instrument holder, and is adapted for traveling over the surface along the curve prescribed by the cable.

According to another preferred embodiment of the invention, the mobile housing includes an outer shell and a base. The outer shell defines a cable opening through which the cable is extended and retracted.

According to another preferred embodiment of the invention, the base has a plurality of wheels.

According to another preferred embodiment of the invention, the wheels are respective ball bearings.

According to another preferred embodiment of the invention, a cable spool is attached to the base and adapted for carrying a length of the cable wound on the spool.

According to another preferred embodiment of the invention, a ratchet wheel is attached to the cable spool, and includes a plurality of teeth formed along a rim of the wheel.

According to another preferred embodiment of the invention, a pivoted locking lever is adapted for movement between a rim-engaging position between adjacent ones of the teeth and a released position spaced-apart from the teeth. In the released position, the lever allows rotation of the ratchet wheel and cable spool in a cable-unwinding direction, thereby extending the cable outwardly from the mobile housing. In the rim-engaging position, the lever prevents rotation of the ratchet wheel and cable spool in the cable-unwinding direction, thereby fixing the length of cable extending outwardly from the mobile housing.

According to another preferred embodiment of the invention, a spring-loaded release pin is adapted for operatively engaging the locking lever to move the locking lever between the rim-engaging and released positions.

According to another preferred embodiment of the invention, an interior guide post is attached to the base, and is adapted for guiding the cable through the cable opening formed in the outer shell of the mobile housing.

According to another preferred embodiment of the invention, the instrument holder includes an elongated hollow tube extending generally perpendicular to the base.

According to another preferred embodiment of the invention, a compression sleeve is formed around the hollow tube and includes a plurality of resilient fingers. The hollow tube defines a plurality of longitudinal slots for receiving the resilient fingers to frictionally engage and hold the surface-engaging instrument.

According to another preferred embodiment of the invention, a ring is located at the free end of the cable, and is adapted for being secured to an object anchored to the surface.

In yet another embodiment, the invention is a compass for marking, scoring or cutting curves on a surface. The compass includes a mobile housing. An instrument holder is attached to the housing, and is adapted for receiving and holding a surface-engaging instrument. A cable spool is formed around the instrument holder, and is located within the housing. A cable is wound on the cable spool. The cable has a proximal end secured to the cable spool and a free end adapted for being anchored to the surface a selected distance from the holder. The selected distance defines a radius of a curve formed by operation of the compass.

### BRIEF DESCRIPTION OF THE DRAWINGS

Some of the objects of the invention have been set forth above. Other objects and advantages of the invention will appear as the description proceeds when taken in conjunction with the following drawings, in which:

FIG. 1 is a side elevation view of the cable compass according to one preferred embodiment of the invention, and showing the compass in operation with the marking instrument inserted and the cable partially extended and anchored to the surface being marked;

FIG. 2 is a rear elevation of the cable compass with the marking instrument inserted;

FIG. 3 is a front elevation of the cable compass with the marking instrument inserted;

FIG. 4 is a top plan view of the cable compass with the cable partially extended, and the marking instrument removed;

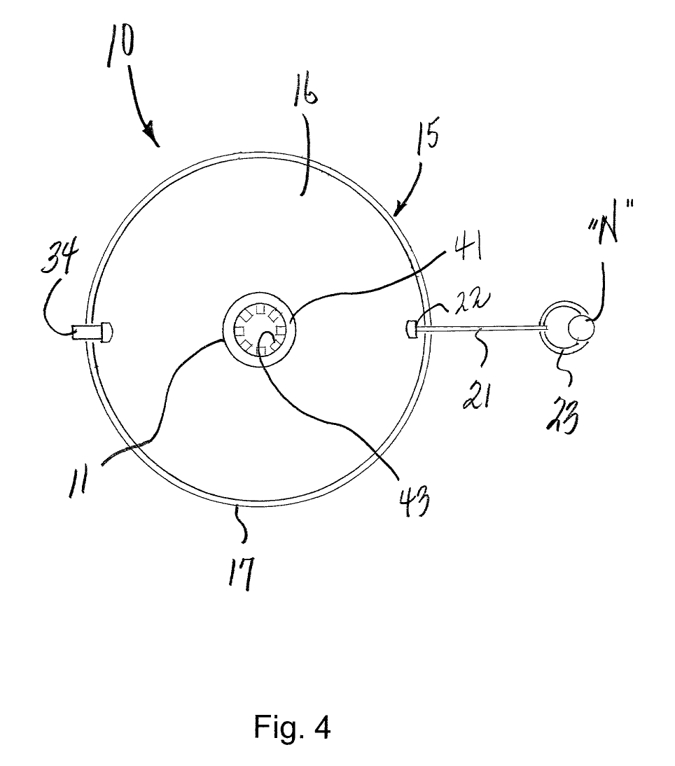

FIG. 5 is a bottom plan view of the cable compass with the cable partially extended, and the marking instrument removed;

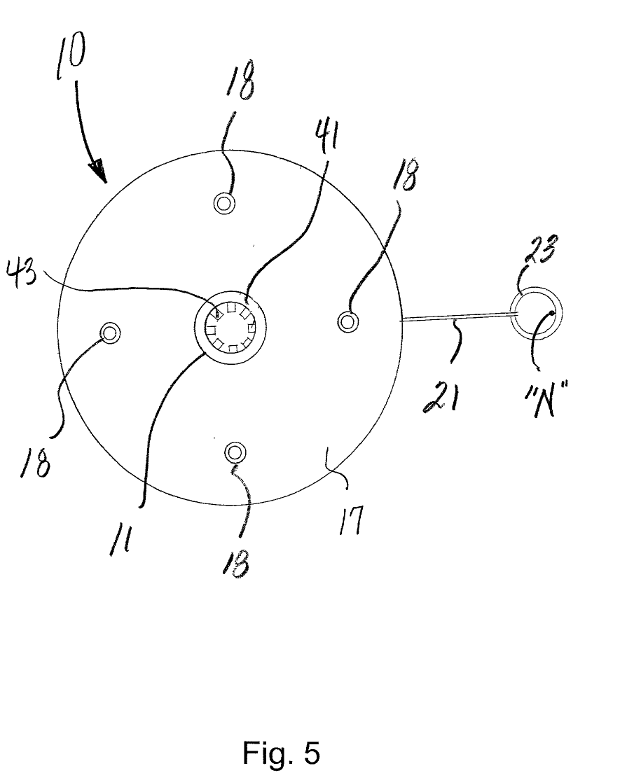

FIG. 6A is a vertical cross-sectional view of the cable compass taken substantially along line 6-6 of FIG. 7, and showing the locking lever in a rim-engaging position preventing unwinding rotation of the cable spool;

FIG. 6B is a vertical cross-sectional view of the cable compass with the locking lever in a released position allowing unwinding rotation of the cable spool to extend the cable from the mobile housing;

FIG. 7 is a horizontal cross section view of the cable compass taken substantially along line 7-7 of FIG. 6A.

### DESCRIPTION OF THE PREFERRED EMBODIMENT AND BEST MODE

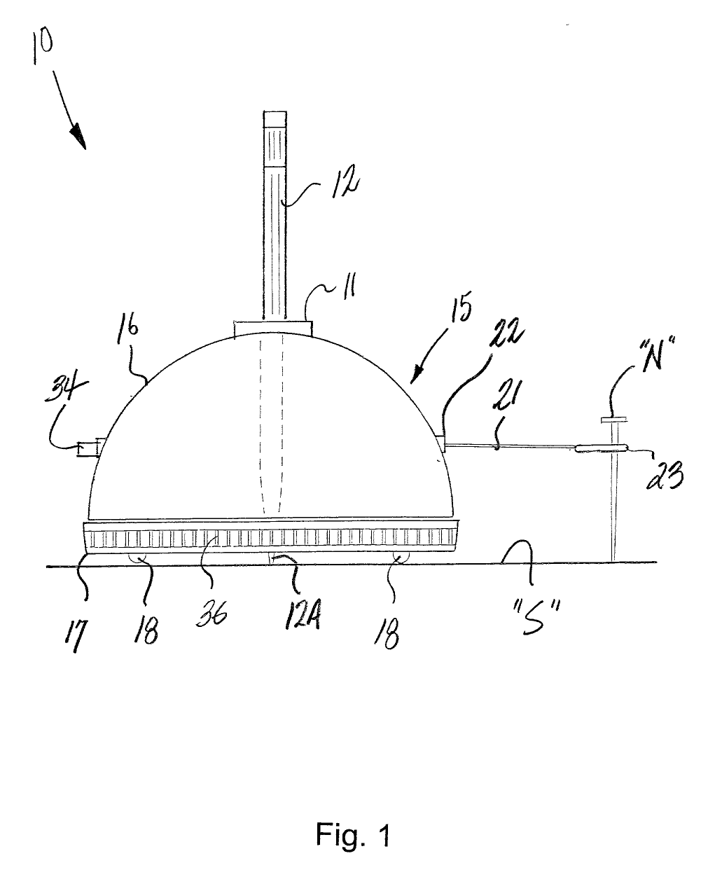

Referring now specifically to the drawings, a cable compass according to the present invention is illustrated in FIG. 1, and shown generally at reference numeral 10. The cable compass 10 is especially applicable for marking, cutting, or scoring arcs or circles of large radii. The cable compass 10 is operable on any flat surface “S”.

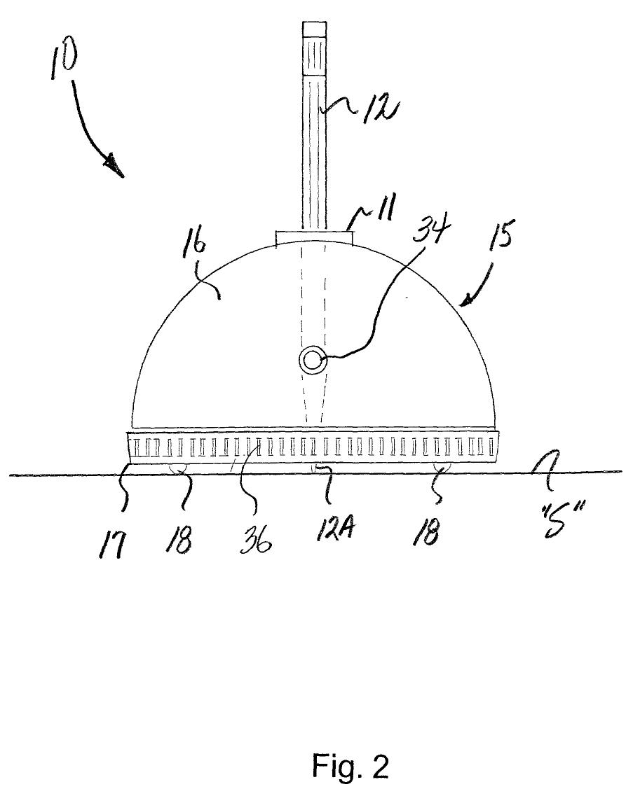

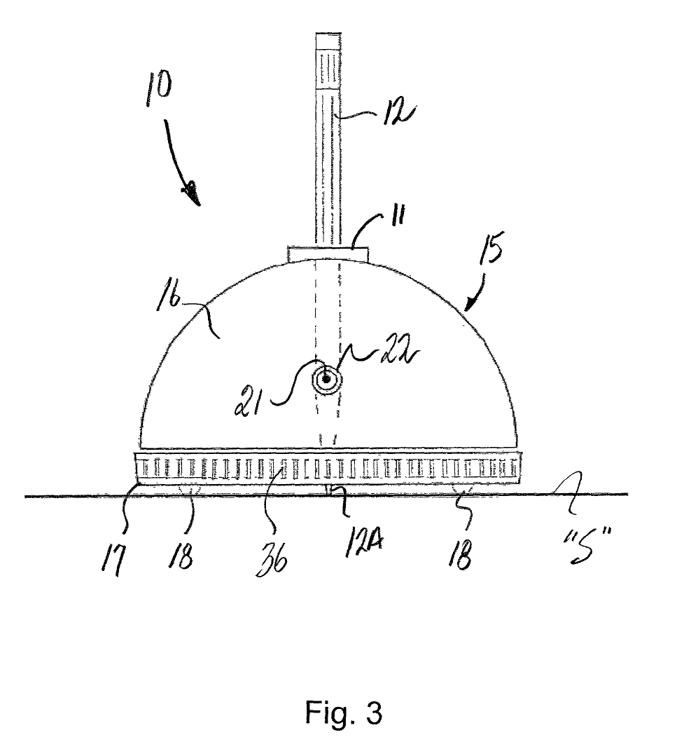

Referring to FIGS. 1-3, the cable compass 10 includes a tubular instrument holder 11 adapted for receiving and holding a surface-engaging instrument 12, such as a lead pencil or other marking or cutting stylus. The instrument holder 11, described further below, is contained within a mobile housing 15 including a semi-spherical outer shell 16 and base 17. The base 17 has wheels 18, such as ball bearings, to facilitate movement of the mobile housing 15 over the surface “S”. An elongated cable 21 extends and retracts through a cable opening 22 formed in the outer shell 16 of the mobile housing 15, and is anchored to the surface “S” at its free end using a nail “N” or other suitable anchoring means. The cable 21 is formed of a non-shrinkable, non-stretchable, and laterally flexible yarn, wire, or other material. Preferably, a ring 23 is attached to the free end of the cable 21 to releasably hold the cable 21 in tension to the nail “N” during operation of the compass 10.

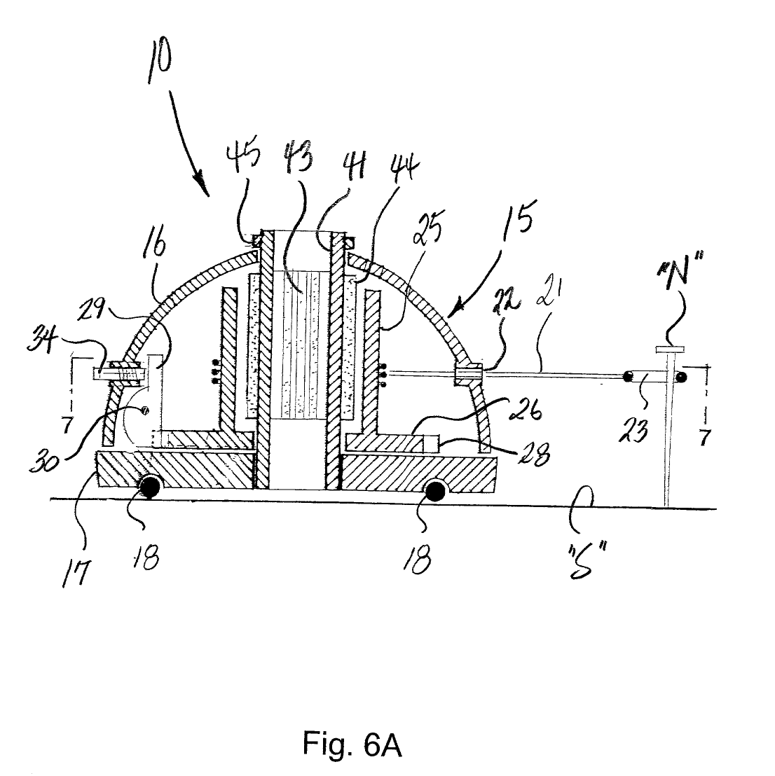

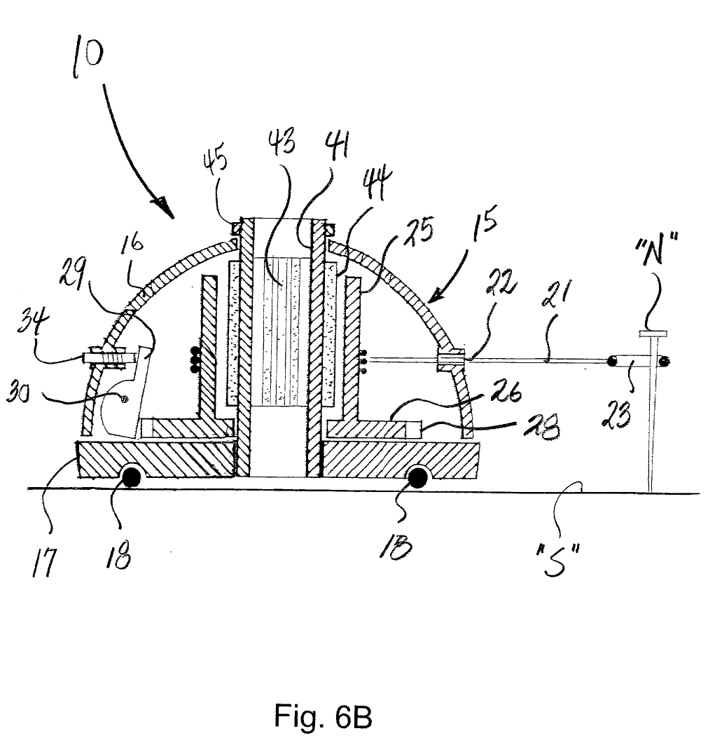

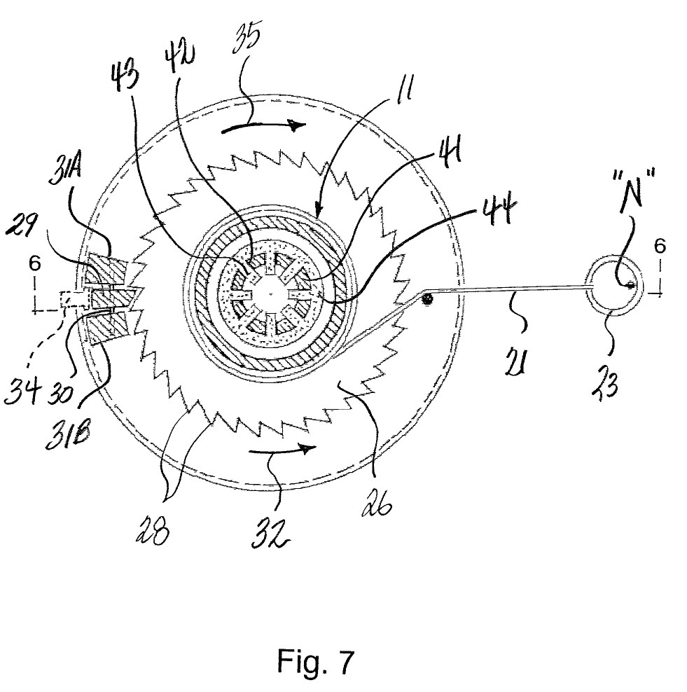

As best shown in FIGS. 6A, 6B, and 7, the proximal end of the cable 21 is secured to a cable spool 25 located inside the mobile housing 15. The cable spool 25 is fixed to the base 17, and is rotatable with the base 17 relative to the outer shell 16 to wind and unwind the cable 21 on the spool 25. A ratchet wheel 26 is formed with the bottom end of the cable spool 25 and includes a number of circumferentially-arranged teeth 28. The teeth 28 are preferably slanted in a counterclockwise direction around the rim of the wheel 26. A pivoted locking lever 29 is located inside the shell 16 of the mobile housing 15, and is carried on a horizontal pin 30 extending between spaced-apart mounting blocks 31A and 31B shown in FIG. 7. The locking lever 29 resides in a normal rim-engaging position, shown in FIG. 6A, between adjacent ones of the teeth 28. In the rim-engaging position, the locking lever 29 prevents cable-unwinding rotation of the ratchet wheel 26 and spool 25 in the direction indicated at 32. By depressing a spring-loaded release pin 34, the locking lever 29 is moved from the rim-engaging position to a released position shown in FIG. 6B. In the released position, the locking lever 29 is spaced from the teeth 28, and allows counterclockwise rotation of the ratchet wheel 26 and spool 25 to unwind and extend the cable 21 from the mobile housing 15. The cable 21 is rewound onto the cable spool 25 and retracted into the mobile housing 15 by manually rotating the base 17 clockwise in a cable-winding direction indicated by direction arrow 35. During rewinding, the locking lever 29 remains in the rim-engaging position and slides over the slanted teeth 28 of the ratchet wheel 26 when rotated. A textured band 36 is preferably formed around an exterior of the base 17 to facilitate gripping and rotation.

The instrument holder 11 passes centrally through the mobile housing 15, and includes an elongated hollow tube 41 extending perpendicular to the base 17. As best shown in FIG. 7, the hollow tube 41 defines a number of longitudinal slots 42 which receive resilient fingers 43 of a rubber compression sleeve 44 formed around the tube 41. The resilient fingers 43 serve to frictionally engage and hold the instrument 12 in a plumb, vertical position such that the point 12A of the instrument 12 maintains contact with the surface “S” during operation of the cable compass 10. A retaining ring 45, shown in FIGS. 6A and 6B, is secured to the top end of the hollow tube 41 to retain the outer shell 16 in position over the base 17.

Operation of the Cable Compass 10

To use the cable compass 10, the operator first inserts a selected marking, cutting or scoring instrument 12 into the instrument holder 11. The point 12A of the instrument 12 is positioned to operatively engage the surface “S”. The operator then determines the size and location of the desired curve or circle to be formed on the surface. The anchor nail “N” is then mounted to the surface “S” at a notional center point of the curve or circle. The ring 23 at the free end of the cable 21 is then applied to the mounted anchor nail “N” and the cable 21 extended from the mobile housing 15 by depressing the release pin 34 projecting from the outer shell 16. The cable 21 is extended a selected distance corresponding to the desired radius of the curve or circle, the distance being measured from a center of the instrument holder 11 to a free end of the tensioned cable 21 held by the anchor nail “N”. Once the cable 21 is sufficiently extended, the release pin 34 is released causing the locking lever 29 to move back into its rim-engaging position preventing further unwinding and extension of the cable 21. With the cable 21 extended and fully tensioned, the operator maneuvers the mobile housing 15 over the surface “S” in an arcuate path. As the mobile housing 15 moves over the surface “S”, the instrument 12 forms the desired curve or circle. After forming the curve or circle, the operator removes the ring 23 from the anchor nail “N” and retracts the cable 21 into the mobile housing 15 by rotating the base 17 and winding the cable 21 back onto the spool 25.

The cable compass and its parts are preferably made of metal or any hard molded plastic. The dimensions may vary according to the particular application. It should also be recognized that, while the invention has been described in relation to a preferred embodiment, those skilled in the art may develop a wide variation of structural details without departing from the principles of the invention. Accordingly, the above descriptive operation and details are to be construed to cover all equivalents falling within the scope and spirit of the invention.

A cable compass is described above. Various details of the invention may be changed without departing from its scope. Furthermore, the foregoing description of the preferred embodiment of the invention and best mode for practicing the invention are provided for the purpose of illustration only and not for the purpose of limitation—the invention being defined by the claims.

I Claim:

1. A compass for marking, scoring or cutting curves on a surface, said compass comprising:
(a) an instrument holder adapted for receiving and holding a surface-engaging instrument; and
(b) an adjustable-length cable having a proximal end secured to said holder and a free end for being anchored to the surface a selected distance from said holder, said distance defining a radius of a curve formed by operation of said compass.

2. A compass according to claim 1, and comprising a mobile housing attached to said instrument holder and adapted for traveling over the surface along a circumference prescribed by said cable.

3. A compass according to claim 2, wherein said mobile housing comprises an outer shell and a base, the outer shell defining a cable opening through which said cable is extended and retracted.

4. A compass according to claim 3, wherein said base comprises a plurality of wheels.

5. A compass according to claim 4, wherein said wheels comprise respective ball bearings.

6. A compass according to claim 3, and comprising a cable spool attached to said base and adapted for carrying a length of said cable wound on said spool.

7. A compass according to claim 6, and comprising a ratchet wheel attached to said cable spool, and including a plurality of teeth formed along a rim of said wheel.

8. A compass according to claim 7, and comprising a pivoted locking lever adapted for movement between a rim-engaging position between adjacent ones of said teeth and a released position spaced-apart from said teeth, whereby:
(i) in the released position, said lever allows rotation of said ratchet wheel and cable spool in a cable-unwinding direction, thereby extending the cable outwardly from said mobile housing; and
(ii) in the rim-engaging position, said lever prevents rotation of said ratchet wheel and cable spool in the cable-unwinding direction, thereby fixing the length of cable extending outwardly from said mobile housing.

9. A compass according to claim 8, and comprising a pin adapted for operatively engaging said locking lever to move said locking lever between the rim-engaging and released positions.

10. A compass according to claim 3, and comprising an interior guide post attached to said base and adapted for guiding said cable through the cable opening formed in said outer shell.

11. A compass according to claim 3, wherein said instrument holder comprises an elongated hollow tube extending generally perpendicular to said base.

12. A compass according to claim 11, and comprising a compression sleeve formed around said hollow tube and including a plurality of resilient fingers, and wherein said hollow tube defines a plurality of longitudinal slots for receiving the resilient fingers therethrough to frictionally engage and hold the surface-engaging instrument.

13. A compass according to claim 1, and comprising a ring located at the free end of said cable and adapted for being secured to an object anchored to the surface.

14. A compass for marking, scoring or cutting curves on a surface, said compass comprising:
(a) a mobile housing;
(b) an instrument holder attached to said housing and adapted for receiving and holding a surface-engaging instrument;
(c) a cable spool formed around said instrument holder and located within said housing; and
(d) a cable wound on said cable spool, and having a proximal end secured to said cable spool and a free end adapted for being anchored to the surface a selected distance from said holder, said distance defining a radius of a curve formed by operation of said compass.

15. A compass according to claim 14, wherein said mobile housing comprises an outer shell and a base, the outer shell defining a cable opening through which said cable is extended and retracted.

16. A compass according to claim 15, wherein said base comprises a plurality of wheels.

17. A compass according to claim 16, wherein said wheels comprise respective ball bearings.

18. A compass according to claim 14, and comprising a ratchet wheel attached to said cable spool, and including a plurality of teeth formed along a rim of said wheel.

19. A compass according to claim 18, and comprising a pivoted locking lever adapted for movement between a rim-engaging position between adjacent ones of said teeth and a released position spaced-apart from said teeth, whereby:
(i) in the released position, said lever allows rotation of said ratchet wheel and cable spool in a cable-unwinding direction, thereby extending the cable outwardly from said mobile housing; and
(ii) in the rim-engaging position, said lever prevents rotation of said ratchet wheel and cable spool in the cable-unwinding direction, thereby fixing the length of cable extending outwardly from said mobile housing.

20. A compass according to claim 19, and comprising a pin adapted for operatively engaging said locking lever to move said locking lever between the rim-engaging and released positions.

21. A compass according to claim 14, wherein said instrument holder comprises an elongated hollow tube extending generally perpendicular to said base.

22. A compass according to claim 21, and comprising a compression sleeve formed around said hollow tube and including a plurality of resilient fingers, and wherein said hollow tube defines a plurality of longitudinal slots for receiving the resilient fingers therethrough to frictionally engage and hold the surface-engaging instrument.
